(19) United States
(12) Patent Application Publication
(10) Pub. No.: US 2008/0314262 A1
(43) Pub. Date: Dec. 25, 2008

(54) APPARATUS AND METHOD FOR CUTTING PRODUCE IN A CONTINUOUS CURL FOR THE PURPOSE OF MAKING A CURLY SPIRALED POTATO CHIP

(76) Inventor: Steven Stark, New York, NY (US)

Correspondence Address: Law Offices of Daniel L. Dawes, 5200 Warner Blvd, Ste. 106, Huntington Beach, CA, 92649, US

(21) Appl. No.: 12/140,565

(22) Filed: Jun. 17, 2008

Related U.S. Application Data
(60) Provisional application No. 60/945,423, filed on Jun. 21, 2007.

(51) Int. Cl. A47J 17/16; A23P 1/10

(52) U.S. Cl. 99/595; 426/518

(57) ABSTRACT

An apparatus for manufacturing a curly sliced potato chip includes: a base frame; a cutting blade coupled to the base frame; and a rotatable threaded rod having a predetermined threaded pitch to which rod the potato is mounted. The rod is turned to rotate the potato while it is in a cutting position and to displace it toward or away from the cutting blade. A quick release engaging member has a threaded portion with a pitch compatible with the pitch of the rod. The member is fixed relative to the base frame and is selectively coupled with the threaded rod to selectively drive the potato mounted on the rod toward or away from the cutting blade as the rod is rotated. The potato is displaced toward or away the cutting blade at a linear displacement rate determined by the pitch of the threaded rod.

### RELATED APPLICATIONS

The present application is related to provisional application Ser. No. 60/945,423, filed on Jun. 21, 2007, which is incorporated herein by reference and to which priority is claimed pursuant to 35 USC 119.

### BACKGROUND OF THE INVENTION

1. Field of the Invention

The invention relates to the field of cutting produce, specifically cutting them into continuous, curl shaped chips.

2. Description of the Prior Art

Many devices and methods have long existed in the art for cutting produce such as potatoes, apples, and the like for many years. Prime examples of such devices include the apparatus found in U.S. Pat. No. 2,464,993 (“Ross”) that shreds and strings potatoes, and the apparatus found in U.S. Pat. No. 5,784,942 (“Jones”) that slices potatoes into spirals via a motorized threaded shaft. Both Ross and Jones are hereby incorporated by reference in their entirety.

Currently, there are also numerous examples of apple peelers and de-corers which are designed to cut thick pieces of fruit and remove their cores for use in pies and other cooking utilities. Also prevalent in the market are a variety of multi-purpose plastic spiral vegetable cutters which are used to make salads and other vegetable dishes less time consuming to make and easier to accomplish.

While these various fruit and vegetable cutters and peelers are not without their successes, they also have multiple drawbacks and limitations as well. For example, many fruit and vegetable cutters utilize a sliding mechanism which pushes the produce toward a blade, thus resulting in uneven cuts and increasing the difficulty of use. Other existing devices that are capable of slicing chips from a piece of produce are only able to make relatively small chips because the front coring knife used to hold the produce in place uses up a large portion of the produce itself. Additionally, apparatus such as those disclosed in Ross and Jones are bulky and are difficult to assemble and disassemble and store when the apparatus is not in use.

What is needed is an apparatus that has the ability to cut produce into thin, evenly sliced continuous curly slices that is inexpensive to make, easy to assemble and dissemble, and convenient to store when not in use.

### BRIEF SUMMARY OF THE INVENTION

The invention disclosed herein is a cutting apparatus for cutting produce into a substantially continuous and curly slice. The invention will be described specifically slicing a potato, but it is to be expressly understood that any fruit or vegetable may used with substantially the same results. Using the currently described apparatus, a curly spiral potato chip can be made by first cutting the potato into a continuous spiral slice and then deep frying or baking the slice. A spring release mechanism provides a quick release of the driving force on the threaded rod to immediately stop the cutting process. The resulting potato chip has a uniform thickness and a long, continuous curly shape that is desired by many consumers, which shape is defined by the pitch of the threads rather than by the pressure manually exerted on the slicer as in prior art devices. As described below, the apparatus thus provides a less expensive and safer method for making potato chips that is simpler to use than the prior art potato chip makers.

To operate the apparatus, a potato or other vegetable or fruit is mounted onto a spinner which is coupled to a threaded rod which in turn is coupled to a handle. When the handle is rotated clockwise, the threaded rod is driven forward, thus spinning the potato about its horizontal axis and driving the potato forward in the lateral direction. A base mounted to a table or counter holds the threaded rod and potato in a fixed vertical position and also supports a fixed blade on the far end of the apparatus. As the handle continues to rotate, the potato is driven to the far end of the apparatus until contact with the fixed blade is made.

Once the blade has made contact with the potato, the handle continues to be rotated thus spinning the potato on top of the blade. The blade itself is set off at an angle with respect to the base and when the potato spins against it, the blade slices into the potato. As the potato continues to spin, the blade continues to slice deeper into the potato, thus forming a uniformly thin spiral cut. The threaded rod meanwhile continues to drive the remaining uncut potato into the fixed blade thus providing a continuous spiral cut potato slice. If the handle is rotated counterclockwise, the threaded rod is driven back in the proximal direction and the potato comes off of the fixed blade and slicing terminates.

This process may be done for an entire potato to provide a single lengthy spiral cut chip, or be done as many times as desired by the user in order to provide several smaller spiral cut chips.

The threaded rod is coupled to the base of the apparatus via a novel spring activated quick release mechanism. An elongated aperture having both a lower internal threaded region and an opposing upper internal non-threaded region is coupled to the apparatus base via a small spring. In order to slide the threaded rod into the aperture, the user must compress the spring by pushing down on the engaging member comprising the aperture itself. When the aperture moves down, the inner threaded region also moves down, leaving the upper nonthreaded region available to accommodate the threaded rod. Since only the nonthreaded region of the aperture is exposed, the rod is free to smoothly slide into the aperture. Once the rod has been appropriately placed, the user releases the engaging member and the spring recoils and pushes the aperture and thus the inner threaded region back into its original position. As a result, the inner threaded region then engages the threads on the rod above it which allows the rod to be in a supported fixed vertical position as the handle coupled to the rod is being rotated. Thus, the spring and engaging member provide a quick release and engaging mechanism for coupling the threaded rod to the base of the apparatus.

In another embodiment, the quick release and engaging mechanism comprises a push down button, that when depressed, pushes down a U-channel with a substantially smooth inner surface which allows the threaded rod to easily slide in and out of the aperture. When the push down button is released, a spring pushes a threaded shuttle upwards thus engaging its internally threaded surface with the threads on the rod.

Both embodiments of the quick release mechanism described above allow the apparatus to be easily assembled and disassembled every time it is needed by the user. Having the ability to quickly remove the threaded rod of the device not only adds to the convenience of the apparatus, but also aides in the user being able to store the apparatus when not in use in a more efficient manner. With the threaded rod and handle removed, the apparatus becomes significantly less bulky and is easier to store or pack into a smaller area than its prior art predecessors. Additionally, the present apparatus is also much safer than other fruit and vegetable slicers, because if the user needs to immediately stop the driving force being applied to the threaded rod and disengage the potato or other object from the blade, the quick release mechanism allows for the rod to be instantly pulled back and thus clear any object from the blade almost immediately. This feature is clearly more advantageous and safer than the method presented in the prior art of disengaging an object from a blade by rotating the handle counterclockwise until the object is slowly driven back into the opposite direction away from the blade.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a perspective view of a preferred embodiment of a cutting apparatus shown as being operated to cut a potato into a continuous curly chip.

FIG. 2A is a perspective view as seen when the handle is on the right of the apparatus in its assembled state without engagement with a potato or other vegetable or fruit to be cut.

FIG. 2B is an exploded perspective view of the apparatus of FIG. 2A in its disassembled state.

FIG. 3A is an exploded perspective view of the apparatus when the handle is on the left showing all of its various components.

FIG. 3B is a perspective view of the apparatus of FIG. 3A after it has been assembled.

FIG. 4A is an exploded perspective view of the base frame of the apparatus.

FIG. 4B is a cross sectional view of the end support.

FIG. 5 is a magnified perspective view of the engaging member of the apparatus.

FIG. 6 is an exploded perspective view of an alternate embodiment of the apparatus comprising a push down button quick release mechanism.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

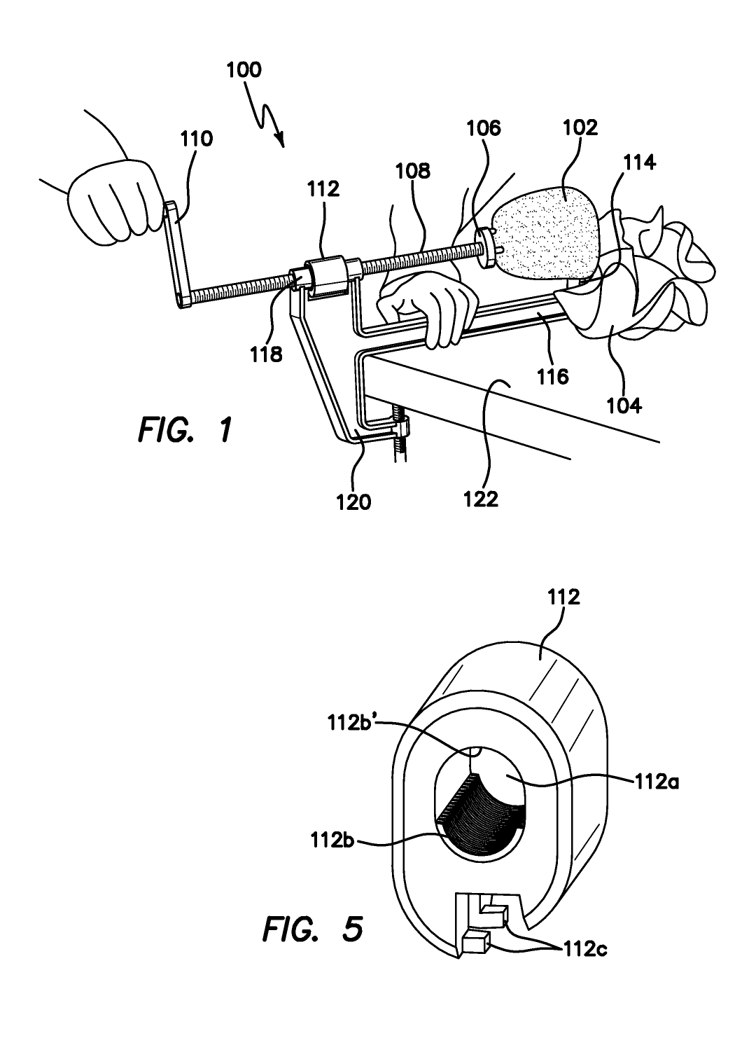

FIG. 1 is a perspective view of a preferred embodiment of a cutting apparatus, generally denoted by reference numeral 100, being operated cut a potato 102 into a continuous curly chip 104. As shown, the potato is non-rotatably mounted on a spinner 106 which is driven through by a threaded rod 108 towards the distal end of the apparatus 100 by manually rotating a handle 110. When the threads on the rod 108 are engaged with the engaging member 112, cranking the handle 110 clockwise will drive the rod 108 forward. As the potato 102 comes into contact with the cutting blade 114 anchored to the base 116 of the apparatus, it is cut into the continuous chip 104 while being stepped forward by the rod 108 and being rotated by the spinner 106. The thickness of the chip 104 is defined by the pitch of the threading of the rod 108.

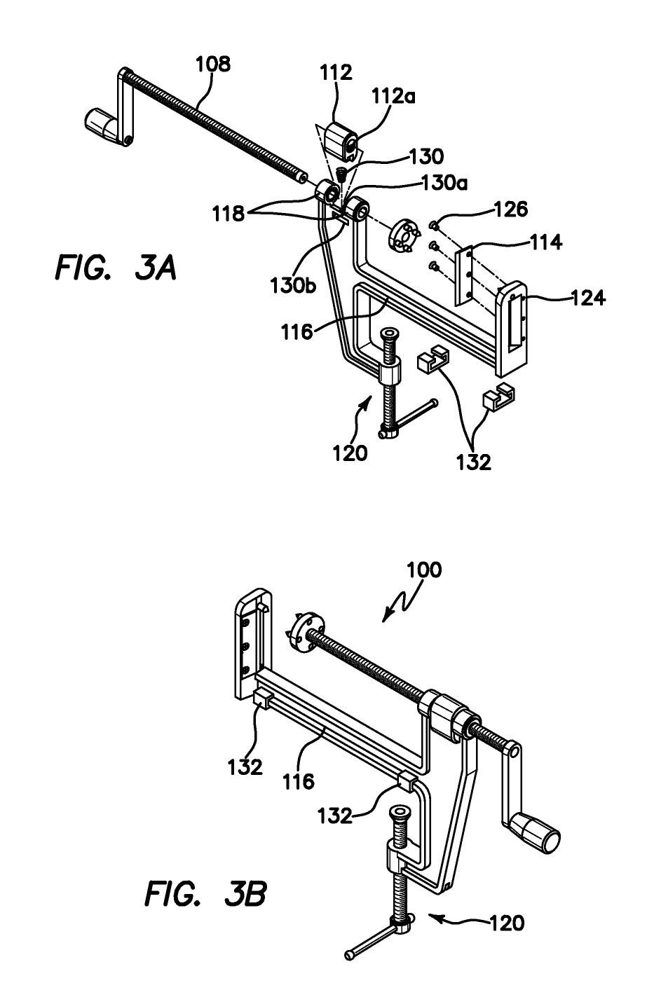

The base 116 provides support to the rod 108 though one or more supporting members 118, which have an bore 112a as best shown in FIG. 3A through which the rod 108 extends. Also depicted in FIG. 1, the base 116 is also coupled to a securing bracket 120 for temporarily fixing the apparatus 100 to a table 122 or other suitable rigid object. The securing bracket 120 may be part of the base 116 itself as shown, or be a separate piece.

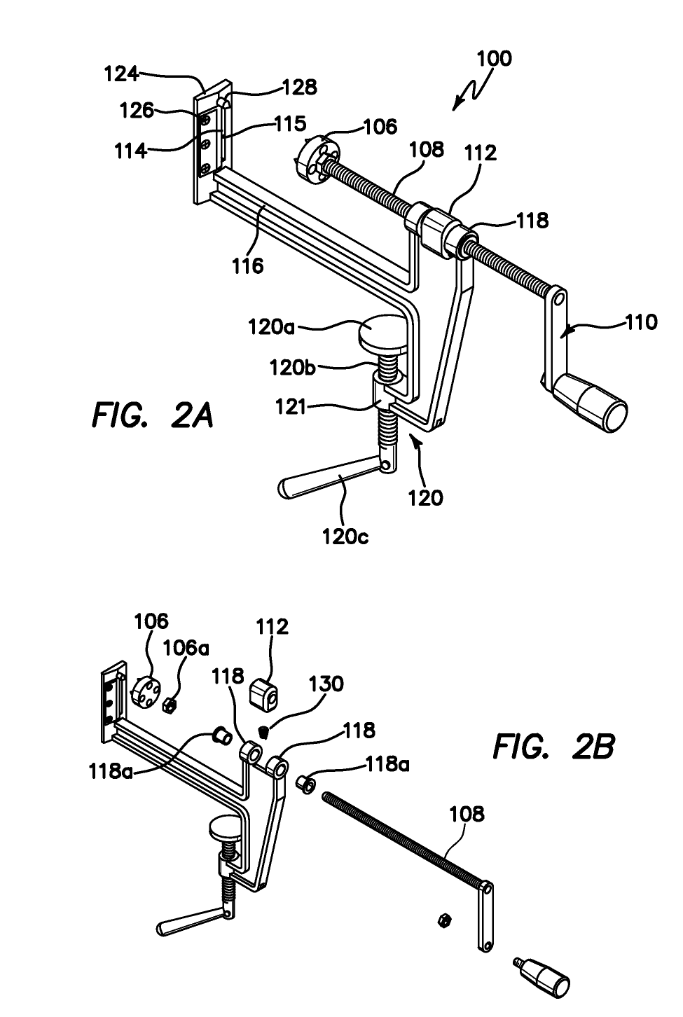

FIG. 2A is a perspective, conceptual view of the apparatus 100. FIG. 2B is an exploded perspective view of the apparatus 100 in its unassembled state, showing the components of the apparatus 100. As shown in FIG. 2A the cutting blade 114 is coupled to an end support 124 on an end of the base 116 using one or more screws 126. It is to be expressly understood that other means for coupling the blade 114 to the end support 124 such as clips, flanges, bolts, welds, or adhesive may be used without departing from the spirit and scope of the invention. Blade 114 may be permanently attached to end support 124 or detachable to allow for replacement and/or sharpening as needed. A pin 128 is also coupled to the end support 124 for rotatably engaging a potato 102 on the distal end of the apparatus opposite to the spinner 106, thus preventing the potato 102 from altering its rotational axis with respect to the rod 108 as the potato 102 is cut by blade 114 and the chip 104 advance through slot 115 in end support 124.

As shown in FIG. 2B, one or more flanged bearings 118a are used to couple the rod 108 within the support member 118. The engaging member 112 is coupled to the rod 108 through a spring 130 as discussed below. Rod 108 telescopically extends through bearings 118a in support member 118 and through engaging member 112, which is positioned between the two opposing support members 118.

The securing bracket 120 depicted in FIG. 2A includes a flange 120a for pressing a table against the base 116. The flange 120a is driven or tightened against the table by a threaded rod 120b coupled to a threaded bore in fitting 121 extending from bracket 120, which is in turn rotated using a tightening handle 120c. Bracket 120 and base 116 are preferably integral with each other as a single piece, but may be fabricated in two or more sections if desired.

FIG. 2B also depicts the spinner portion of the apparatus. The spinner 106 is secured or fixed to the rod 108 using a bolt 106a, however other means for securing may include screws, welds, or adhesive without departing from the original spirit and scope of the invention. Rod 108 is extendable from support members 118 and is connected to spinner 106 as best shown in FIG. 2A.

A procedure for assembling the apparatus 100 is illustrated in FIG. 3A. The base frame 116 along with the end support member 124 is first coupled together using methods well known in the art. Next, cutting blade 114 is coupled to the end support 124 using screws 126 or other equivalent means. A tapered spring 130 is then coupled to the base frame 116 between a pair of support members 118. The narrowed base of tapered spring 130 may be captured by a post provided in the opposing surface of bracket 120 with the larger opposing end of spring 130 being captured by engaging member 112 as described below in connection with FIG. 5. The engaging member 112 is then placed on top of the tapered spring 130 and between the two support members 118, thereby compressing spring 130 as rod 108 is then extended through the aperture of the support members and the aperture 112a defined in the engaging member 112.

One or more rubber extrusion pads 132 may optionally and removably be coupled to the base frame 116 to protect the surface of the table and to prevent movement of the apparatus 100 when secured to the table using securing bracket 120 as shown in a second embodiment shown in FIGS. 3A and 3B. The securing bracket 120 shown in FIG. 3A is similar to that of a vice, however any other equivalent means in the art may be used such as clips, Velcro, or pneumatic devices without departing from the original scope and spirit of the invention. FIG. 3B depicts the apparatus 100 after it has been assembled following a procedure to that described above.

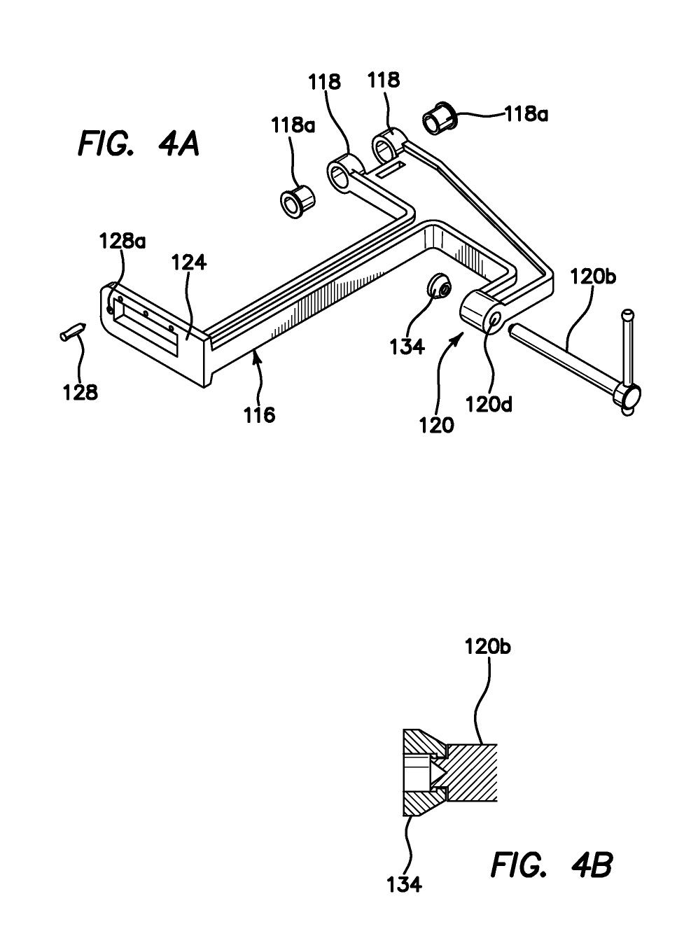

FIG. 4A shows a perspective view of the base frame 116 including the end support 124. The pin 128 is press fit or otherwise fixed into an aperture 128a on the end support 124. The bearings 118a also press fit into the support members 118. A swivel joint 134 or another equivalent joint is coupled to or captured on the end of the threaded rod 120b which is threaded through threaded aperture 120d of the securing means 120. Swivel joint 134 is shown in cross-sectional view of FIG. 4B.

FIG. 5 is a perspective view of the engaging member 112 having aperture 112a with a internally threaded lower area 112b, and bottom tabs 112c. The aperture 112a is substantially elongated or elliptical in cross section. Within the aperture 112a of engaging member 112 there is also a non-threaded upper area 112b′ opposing the threaded area 112b. Normally, spring 130 bearing against the bottom of member 112 as shown in FIG. 5 urges threaded portion 112b upward and into engagement with threaded rod 108 as shown in FIGS. 3A and 3b. Rotation of rod 108 will drive rod 108 toward or away from end support 124 depending on the sense of rotation to cause the potato to be cut by blade 114 or to back blade 114 away from uncut portions of the potato. In the illustrated embodiment, When the rod 108 is rotated clockwise, the rod 108 is driven forward toward the cutting blade 114. When the rod 108 is rotated counterclockwise, the rod 108 withdraws from the cutting blade 114.

When the user pushes down on member 112, spring 130 as shown in FIG. 3A is compressed, causing the threaded area 112b to disengage from the threaded rod 108, which moves upward into nonthreaded upper area 112b′. Thus, when the rod 108 is rotated, there is no horizontal drive force to drive the rod 108 toward or away from the blade 114. In such a disengaged configuration, the rod 108 can be slid horizontally in either direction through the aperture 112a without engagement with the threaded area 112b. When member 112 is released, spring 130 once again urges the threaded area 112b to reengage threaded rod 108. Thus, the combination of spring 130 and member 112 provides a quick release and engaging mechanism. This feature of the engaging member 112 is not only highly convenient for quickly setting up the apparatus 100 in its initial configuration to cut the potato or to disengage the potato from the apparatus 100, but makes the apparatus safe to use because, if at any moment the user wishes to disengage the potato or other object from the blade 114, the rod 108 may be stopped and removed almost instantaneously thereby preventing possible injury to the user.

As best shown in FIG. 3A, the spring 130 may be coupled on its lower end to post 130a on the base frame 116 between the support members 118 and on its opposing upper end to a post or blind hole (not shown) in the engaging member 112. When member 112 is pushed down tabs 112c slide into aperture 130b in the base frame 116, which aperture 130b capture tabs 112c (shown in FIG. 5), thus retaining the engaging member 112 in its disengaged state. When engaging or coupling engaging member 112 to rod 108, the engaging member 112 is rotated slightly to release the tabs 112c from aperture 130b allowing member 112 to be pushed up by spring 130. When spring 130 is subsequently pushes the engaging member 112 upward, threaded section 112b engages with the threads on the rod 108.

Another embodiment for the engaging member 112 of the apparatus 100 may provide the internally threaded section in its top portion and the smooth surface in its bottom portion in a manner reversed from that shown in FIG. 5. In this case when spring 130 is compressed by pushing member 112 downwardly, the rod 108 is engaged with member 112 and released or disengaged from rod 108 when allowed to rise under the urging of spring 130, which is opposite to the exemplary configuration shown in FIG. 5.

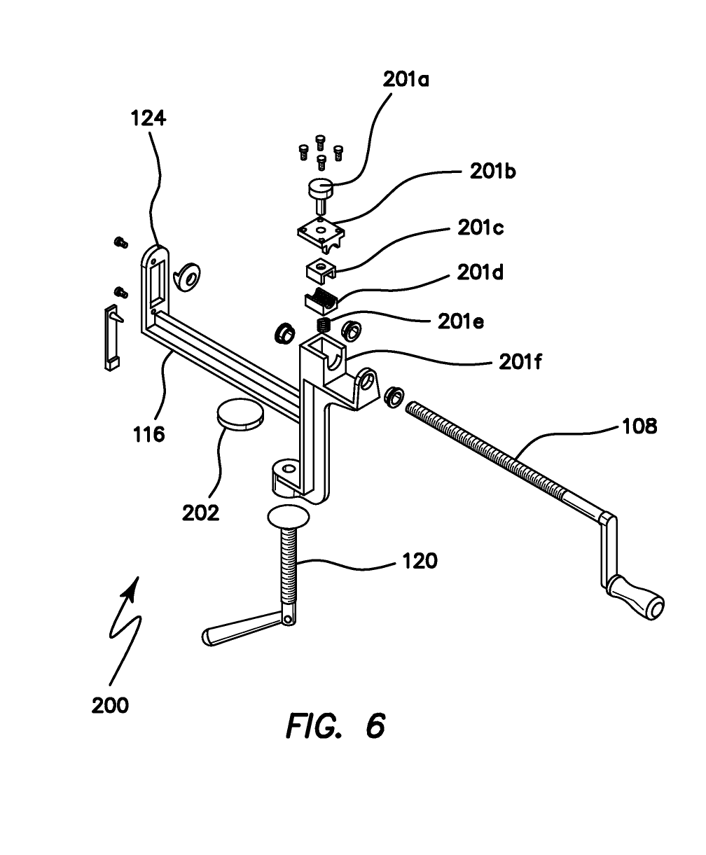

FIG. 6 is an exploded perspective view of an alternative embodiment 200 of the apparatus with an engaging member 201 comprising a push down button 201a. When the push down button 201a is depressed toward or into receiving chamber 201f, button 201a presses down a spring top 201b. The spring top 201b is basically a resilient or flexible cover for a chamber 201f and is coupled to the chamber 201f through a plurality of screws. The spring top 201b in turn pushes a U-channel 201c Into chamber 201f. The U-channel 201c has a substantially smooth inner surface to allow the rod 108 to slide therethrough without engagement with U-channel 201c. When the push down button 201a is released, a compression spring 201e captured between frame 204 and shuttle 201d, which is slidingly captured within chamber 201f, pushes threaded shuttle 201d upwards, engaging its internally threaded inner surface with the threads on the rod 108. Thus, in a manner similar to the embodiment of FIGS. 1-5, rod 108 can be quickly released for adjustment or disengagement by depressing button 201a and then automatically re-engaged with shuttle 201d captured within chamber 201f, but allowing spring 201e to push shuttle 201d against rod 108. Additionally, a rubber cap 202 applied to the top of clamp 120 may be used to protect the surface of a table instead of the rubber extrusion 132 depicted in FIG. 3A.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. An apparatus for slicing a food item comprising:
a base frame;
a cutting blade coupled to the base frame;
a rotatable threaded rod for rotating the food item around an axis while translating the food item toward or away from the cutting blade; and
a quick release engaging member having a threaded portion and being fixed relative to the base frame for selectively coupling with the threaded rod to selectively drive the threaded rod toward or away from the cutting blade as the rod is rotated at a displacement rate determined by a pitch of the threaded coupling between the rod and the quick release engaging member.

2. The apparatus of claim 1 where the quick release engaging member further comprises a spring coupled to the base frame for urging the quick release engaging member into an engaged or disengaged relationship with the threaded rod.

3. The apparatus of claim 2 where the spring urges the quick release engaging member into an engaged relationship with the threaded rod when the quick release engaging member is manually released.

4. The apparatus of claim 2 where the spring urges the quick release engaging member into a disengaged relationship with the threaded rod when the quick release engaging member is manually released.

5. The apparatus of claim 3 further comprising a retaining mechanism defined in the quick release engaging member to selectively retain the quick release engaging member in the disengaged relationship.

6. The apparatus of claim 2 where the quick release engaging member further comprises an aperture with an elongated cross section containing a threaded and an opposing non-threaded region for selective engagement with the threaded rod.

7. The apparatus of claim 1 further comprising a handle wherein the rod is manually rotated.

8. The apparatus of claim 1 further comprising a securing means coupled to the base frame for selective fixing the apparatus of a work location.

9. The apparatus of claim 1 further comprising a spinner coupled to the threaded rod for mounting an food item to be sliced.

10. The apparatus of claim 2 where the quick release engaging member further comprises a means for rapidly engaging and disengaging the threaded rod using a push down button.

11. The apparatus of claim 10 where the means for rapidly engaging and disengaging the threaded rod using a push down button further comprises an internally threaded shuttle coupled to the push down button.

12. An apparatus for manufacturing a curly sliced potato chip from a potato comprising:
a base frame;
a cutting blade coupled to the base frame;
a rotatable threaded rod having a predetermined threaded pitch to which rod the potato is mounted, the rod for rotating the potato around an axis while the potato is in a cutting position and to displace the potato toward or away from the cutting blade as the potato chip is sliced from the potato; and
a quick release engaging member having a threaded portion with a pitch compatible with the pitch of the rod, the member being fixed relative to the base frame, the member for selectively coupling with the threaded rod to selectively drive the potato mounted on the rod toward or away from the cutting blade as the rod is rotated, the potato being displaced toward or away the cutting blade at a linear displacement rate determined by the pitch of the threaded rod.

13. A method for cutting a potato into a curly chip comprising:
mounting the potato on a spinner which is coupled to a threaded rod;
positioning the potato into a cutting position by linear displacement of the rod without rotation of the rod, displacement of the rod being allowed by activation of a quick release engaging member;
selectively engaging the threaded rod with the base frame via a threaded quick release engaging member;
rotating the potato by rotating the threaded rod;
simultaneously slicing the potato by advancing the potato into a fixed blade by rotating the threaded rod while in engagement with the threaded quick release engaging member, where a pitch of threads on the threaded rod determines a ratio between rotational motion of the potato and a translational displacement of the potato by threaded rod toward the fixed blade; and
rapidly terminating the slicing of the potato by selectively activating the quick release engaging member to decouple the rod from the base frame.

14. The method of claim 13 where the rod and frame are normally engaged with each other and where rapidly terminating the slicing of the potato by selectively activating the quick release engaging member to decouple the rod from the base frame comprises disengaging the quick release engaging member from the rod by manually depressing the quick release engaging member against a spring force into a disengaged relationship with the threaded rod.

15. The method of claim 13 where the rod and frame are selectively retained in engagement with each other and where rapidly terminating the slicing of the potato by selectively activating the quick release engaging member to decouple the rod from the base frame comprises disengaging the quick release engaging member from the rod by manually releasing the selective retention of the quick release engaging member in an engaged relationship with the threaded rod.

16. The method of claim 13 where selectively engaging the threaded rod with the base frame and rapidly terminating the slicing of the potato comprises displacing the threaded rod in an aperture with an elongated cross section containing a threaded and an opposing non-threaded region for selective engagement with the threaded rod.

17. The method of claim 13 where selectively engaging the threaded rod with the base frame and rapidly terminating the slicing of the potato comprises rapidly engaging and disengaging coupling of the threaded rod to the base frame using a push down button.

18. The method of claim 17 where rapidly engaging and disengaging the threaded rod using a push down button further comprises displacing an internally threaded shuttle coupled to the push down button.
